(19) United States
(12) Patent Application Publication
(10) Pub. No.: US 2011/0272224 A1
(43) Pub. Date: Nov. 10, 2011

(54) BRAKE SYSTEM FOR AND METHOD FOR BRAKING OF VERTICAL AXIS WIND TURBINE

(76) Inventors: Qiang YAN, Shanghai (CN); Yihui SHEN, Shanghai (CN); Dong ZHANG, Shanghai (CN); Chaoqi JIANG, Shanghai (CN); Haifeng NIU, Shanghai (CN)

(21) Appl. No.: 13/187,558

(22) Filed: Jul. 21, 2011

Related U.S. Application Data
(63) Continuation of application No. PCT/CN2010/000075, filed on Jan. 18, 2010.

(30) Foreign Application Priority Data
Jan. 21, 2009 (CN) 200910003965.5

(51) Int. Cl. F03D 11/00; F16D 55/22; F16D 51/20

(52) U.S. Cl. 188/72.1; 188/78

(57) ABSTRACT

A brake system for a vertical axis wind turbine including a brake device (3) that is connected with the rotor shaft of generator (1) or vertical shaft (2), brake shoes or brake calipers (4) which are controller by the electromagnetic actuator (11), a friction lining (6), as well as a safety pin (5) and a safety pin electromagnetic actuator (22) that controls the safety pin (5).The brake device (3) is a brake drum or a brake disc. The brake system of the invention is able to reduce the vibration of the vertical axis wind turbine in strong wind conditions effectively without the need of reinforcing the wind turbine's ability to withstand strong winds, thus increasing the safety and reliability of the vertical axis wind turbine. A method for braking a vertical axis wind turbine is also provided.

### CROSS-REFERENCE TO RELATED APPLICATIONS

This application is a continuation of International Patent Application No. PCT/CN2010/000075, with an international filing date of Jan. 18, 2010, designating the United States, now pending, and further claims priority benefits to Chinese Patent Application No. 200910003965.5, filed Jan. 21, 2009. The contents of all of the aforementioned applications, including any intervening amendments thereto, are incorporated herein by reference.

### BACKGROUND OF THE INVENTION

1. Field of the Invention

The invention relates to a vertical axis wind turbine, and in particular to a brake system for and method for braking of vertical axis wind turbine.

2. Description of the Related Art

Wind turbines are usually used in adverse weather conditions, and to withstand strong wind, most wind turbines are equipped with a brake system. Large horizontal axis wind turbines nowadays employ disc brake or dram brake, with the axis of the brake disc or brake drum parallel to the ground. For wind turbines with similar rated output, the braking force needed for the horizontal axis wind turbine is much smaller than that for the vertical axis wind turbine, in that the horizontal axis wind turbine is able to yaw or to adjust angle of blades, and the rotor rotates at high speeds and with low torque, while the rotor of the vertical axis wind turbine rotates at low speeds with high torque, unable to yaw or to adjust blades. Therefore, brake devices used in the horizontal axis wind turbine is not suitable for the vertical axis wind turbine with similar output.

### SUMMARY OF THE INVENTION

The object of this invention is to overcome the drawbacks with prior technologies by solving the brake issue of the vertical axis wind turbine.

A brake system for a vertical axis wind turbine, comprising a brake device that is connected with the rotor shaft of generator or vertical shaft, brake shoes or brake calipers which are controlled by the electromagnetic actuator, a friction lining, a safety pin, and a safety pin electromagnetic actuator that controls the safety pin. The brake device is a brake drum or a brake disc, and the axis of the brake device and the axis of the safety pin are perpendicular to the ground. The brake shoes or brake calipers are symmetrically arranged to the axis of the rotor axis.

A method for braking the vertical axis wind turbine, comprising when the wind speed exceeds the cut-out wind speed, the electromagnetic actuator is activated, controlling the brake shoes or brake calipers, and through the friction lining stops the brake device. When the wind speed falls below the cut-out wind speed and braking is not necessary, the electromagnetic actuator is deactivated and controls the brake shoes or brake calipers to return to the original positions.

When the wind speed exceeds the cut-out wind speed and long period braking is necessary, or maintenance services are needed, the electromagnetic actuator is activated, controlling the brake shoes or brake calipers, and through the friction lining stops the brake device; then the safety pin electromagnetic actuator is activated, making the safety pin insert into the corresponding cut, after which the electromagnetic actuator is deactivated and the brake shoes or the brake calipers return to the original positions.

When the wind speed falls below the cut-out wind speed and long time braking is not necessary, the safety pin electromagnetic actuator is deactivated which retracts the safety pin from the corresponding cut to its original positions.

The braking force from the electromagnetic actuator increases from 0 to maximum within 2 minutes, and retains for 4 minutes, with the whole process taking 6 minutes; 5 minutes after the activation of the electromagnetic actuator, the safety pin electromagnetic actuator is activated, making the safety pin insert into the corresponding cut, then the electromagnetic actuator is deactivated and the brake shoes or the brake calipers return to the original positions.

Preferably, when receiving braking signal, the safety pin electromagnetic actuator is activated, and the safety pin goes up and pushes a safety locking device to lock the brake drum, effectively increase the life of the safety pin and cuts downtime. The safety locking device is a cantilever, with one end pivotally fixed and the other end features a prominence. One side of the prominence works with the ribs in the brake drum to brake the brake drum. The cantilever is equipped with a spring. When brake is not applied, the safety locking device keeps untouched with the brake drum, and the wind turbine can rotate freely, while in braking period, the safety pin goes up and pushes the safety locking device to locking the brake drum.

When receiving brake signal, the safety pin electromagnetic actuator is activated, and the safety pin goes up and pushes the safety locking device to lock the brake drum, effectively increases the life of the safety pin and cuts downtime. While on releasing the brake, the safety pin electromagnetic actuator is deactivated, making the safety pin retract and the safety locking device returns to its original position, freeing the wind turbine.

Such brake system is able to reduce the vibration of the wind turbine in strong wind conditions effectively without the needs to reinforce the wind turbine's ability to withstand strong winds, thus increase the safety and reliability of the vertical axis wind turbine.

### BRIEF DESCRIPTION OF THE DRAWINGS

A detailed description of accompanying drawings will be provided below:

FIG. 1 and FIG. 2 are schematic diagrams of the drum brake's structure;

FIG. 3 is a schematic diagram of the structure of the double brake pad disc brake;

FIG. 4 is a schematic diagram of the structure of the single brake pad disc brake;

FIG. 5 is a schematic diagram of the structure of the underlying disc brake;

FIG. 6 is a schematic diagram of the structure of the outer-rotor inner-drum brake;

FIG. 7 is a schematic diagram of the structure of the outer rotor disc brake;

FIG. 8 and FIG. 9 are schematic diagrams of the structure of the inner-rotor inner-drum brake;

FIG. 10 is a schematic diagram of the structure of the hybrid brake;

FIG. 11 is a schematic diagram of the structure of the disc brake without the safety pin;

FIG. 12 is the time logic relation diagram of the activation and deactivation of the electromagnetic actuator 11 and the safety pin electromagnetic actuator 22;

FIG. 13 is the logic relation diagram of the brake system; and

FIG. 14 and FIG. 15 are schematic diagrams of the structure of another type of drum brake.

### REFERENCE CHARACTERS

1-generator; 11(11a, 11b)-braking electromagnetic actuator; 22-safety pin electromagnetic actuator; 2-vertical shaft; 3(3a, 3b)-brake device (brake drum or brake disc); 4(4a, 4b)-brake shoes or brake calipers; 5-safety pin; 6-friction lining; 66-fixed part of the electromagnetic brake; 77-rotating part of the electromagnetic brake; 88-lower flange; and 99-safety locking device.

### DETAILED DESCRIPTION OF THE EMBODIMENTS

Detailed description will be given below in conjunction with accompanying drawings.

### EXAMPLE 1

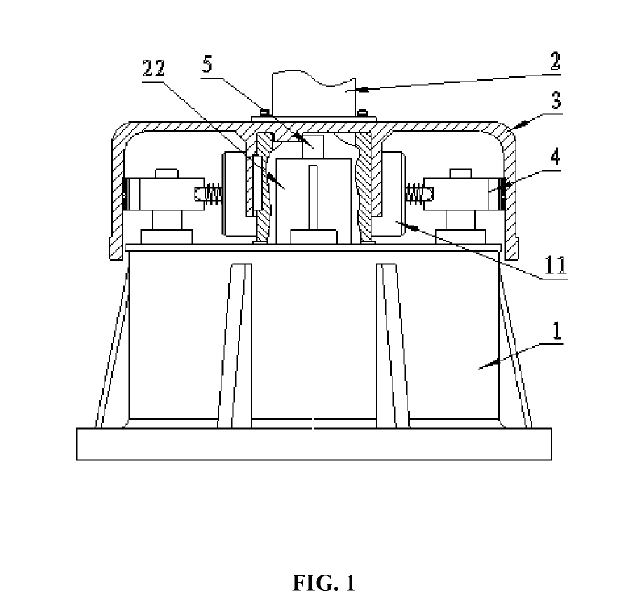

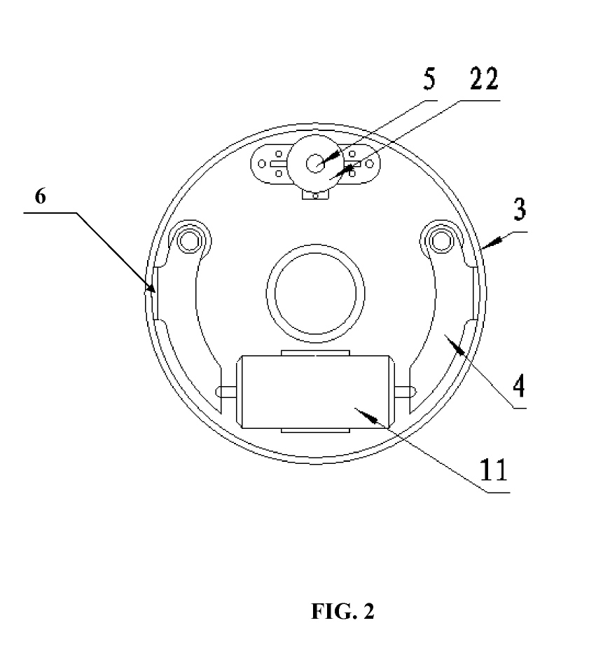

FIG. 1 and FIG. 2 are schematic diagrams of the drum brake's structure. The brake shoes are situated on top of the generator 1 and symmetrically arranged on either side of the rotor shaft. The advantage of such structure is bigger braking force and suitable for vertical axis wind turbine system. The brake structure includes the brake device 3 that rotating with the rotor shaft or vertical shaft, the brake shoes 4 that is controlled by the electromagnetic actuator 11, friction lining 6, the safety pin 5 and the safety pin electromagnetic actuator 22 that controls the safety pin 5; the brake device 3 is a brake drum. The brake device 3 is axially perpendicular to the ground. The safety pin 5 is axially perpendicular to the ground. The brake shoes are symmetrically arranged on either side of the rotor shaft.

When the wind speed exceeds the preset wind speed (cut-out wind speed), the electromagnetic actuator 11 is activated, controlling the brake shoes 4, and through the friction lining 6 stops the brake device 3. When the wind speed falls below the cut-out wind speed and braking is not necessary, the electromagnetic actuator 11 is deactivated and makes the brake shoes 4 returns to the original position.

When the wind speed exceeds the cut-out wind speed and long braking period is necessary, or maintenance services are needed, the electromagnetic actuator 11 is activated, controlling the brake shoes 4, and through the friction lining 6 stops the brake device 3; and then the safety pin electromagnetic actuator 22 is activated, making the safety pin 5 insert into the corresponding cut; then the electromagnetic actuator 11 is deactivated and makes the brake shoes 4 returns to the original position. When the wind speed falls below the cut-out wind speed and long time braking is not necessary, the safety pin electromagnetic actuator 22 is deactivated, making the safety pin 5 retract from the corresponding cut and return to its original position.

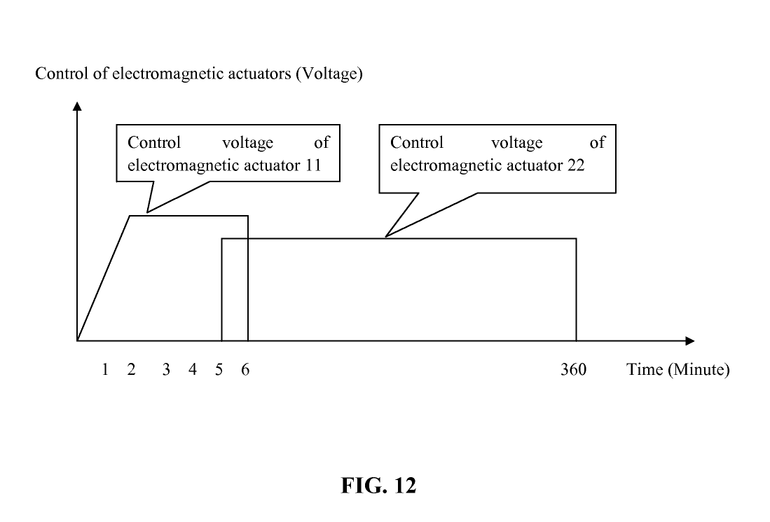

FIG. 12 is the time logic relation diagram of the activation and deactivation of the electromagnetic actuator 11 and the safety pin electromagnetic actuator 22. The braking force from the electromagnetic actuator 11 increases from 0 to maximum within 2 minutes, and retains for 4 minutes, with the whole process taking 6 minutes; 5 minutes after the activation of the electromagnetic actuator 11, the safety pin electromagnetic actuator 22 is activated, making the safety pin 5 insert into the corresponding cut, then the electromagnetic actuator 11 is deactivated and makes the brake shoes 4 returns to the original position.

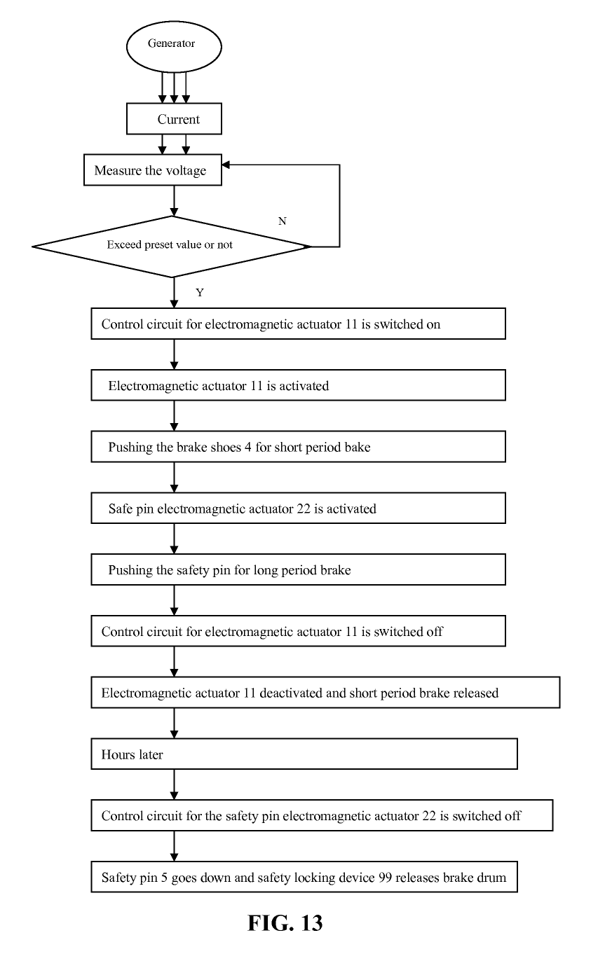

FIG. 12 and FIG. 13 are the logic relation diagrams of the brake system. The electromagnetic actuator 11 is controlled by voltage. By monitoring the generator's voltage output to determine if the voltage exceeds a preset value, the circuit for the electromagnetic actuator 11 is controlled to start the brake shoes 4 for short period baking, and the circuit for the safety pin electromagnetic actuator 22 is controlled to push safety pin 5 for long period braking After a few minutes, the circuit for the electromagnetic actuator 11 is switched off and the electromagnetic actuator 11 controls the brake shoes 4 returns to previous condition, terminating short period braking Hours later, the circuit for the safety pin electromagnetic actuator 22 is switched off, and the safety pin electromagnetic actuator 22 controls the safety pin 5 to retract, terminating long period braking, releasing the wind turbine from braking

### EXAMPLE 2

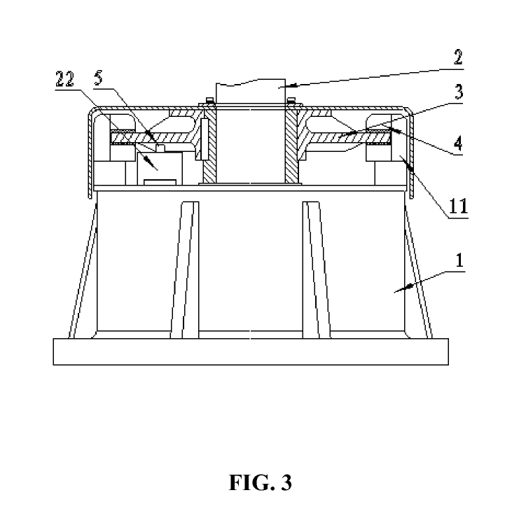

FIG. 3 is a schematic diagram of the structure of the double brake pad disc brake. The brake device 3 is a brake disc and each brake caliper has double brake pads. The rest is similar to implementation 1. The brake disc is situated on top of the generator 1 and parallel to the ground, and the safety pin 5 is situated under the brake disc. Such structure has the advantage of a lighter disc.

### EXAMPLE 3

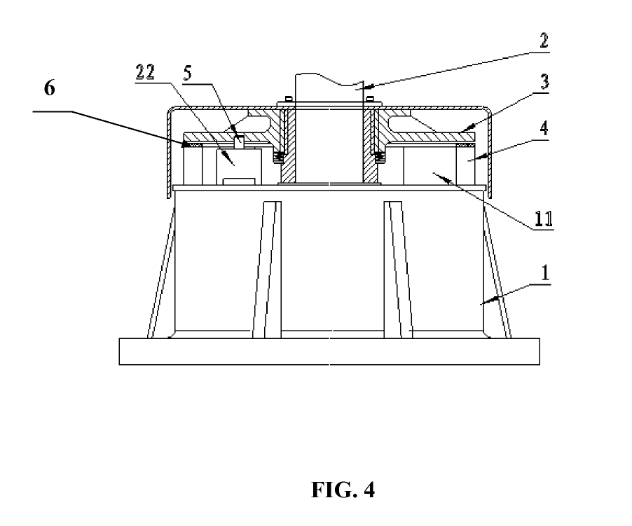

FIG. 4 is a schematic diagram of the structure of the single brake pad disc brake. The brake device is a brake disc and there is one brake pad. The rest is similar to implementation 1. The brake disc is situated on top of the generator 1 and parallel to the ground, and the safety pin 5 is situated under the brake disc. Such structure has the advantage of a lighter disc.

### EXAMPLE 4

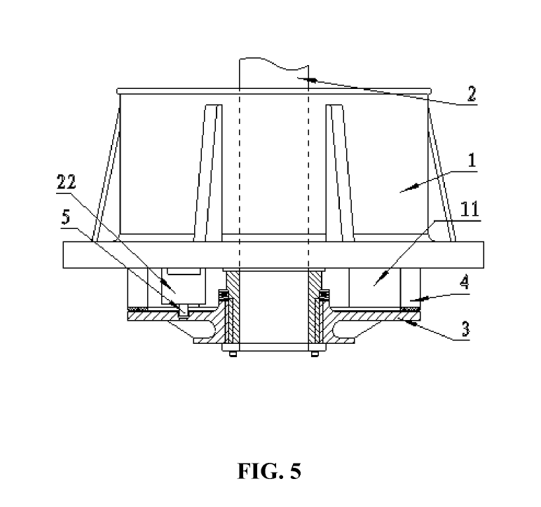

FIG. 5 is a schematic diagram of the structure of the underlying disc brake. The brake device 3 is a brake disc and located under the generator 1. The rest is similar to implementation 3. The brake disc is located under the generator 1 and parallel to the ground, and the safety pin 5 is situated above the brake disc. Such structure offers protection for the brake system while makes maintenance difficult.

### EXAMPLE 5

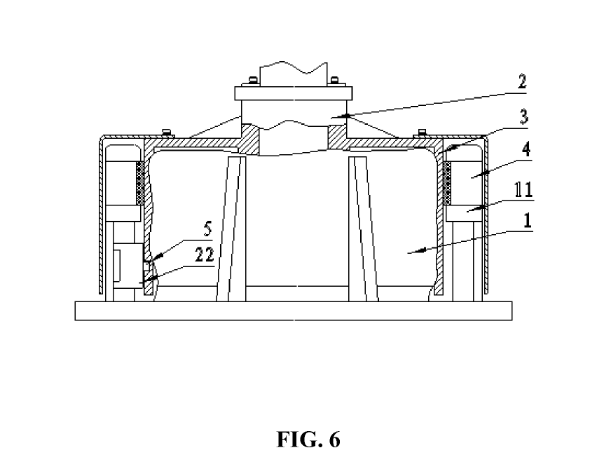

FIG. 6 is a schematic diagram of the structure of the outer-rotor inner-drum brake, and the safety pin is located under the brake shoes.

### EXAMPLE 6

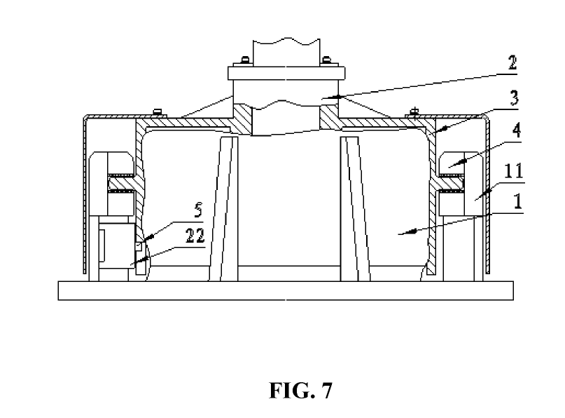

FIG. 7 is a schematic diagram of the structure of the outer rotor disc brake, and the safety pin is located under the brake calipers.

### EXAMPLE 7

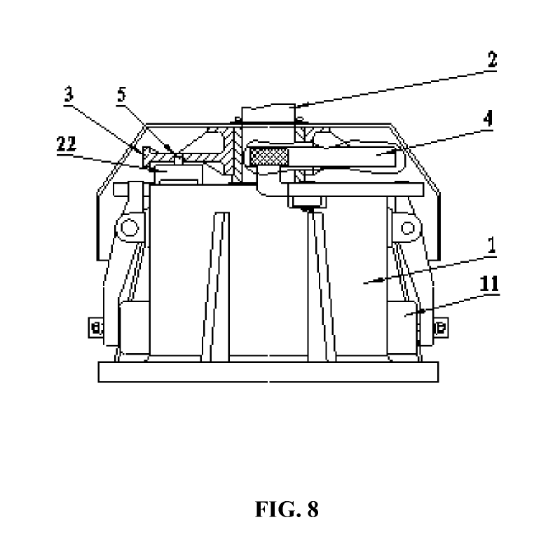

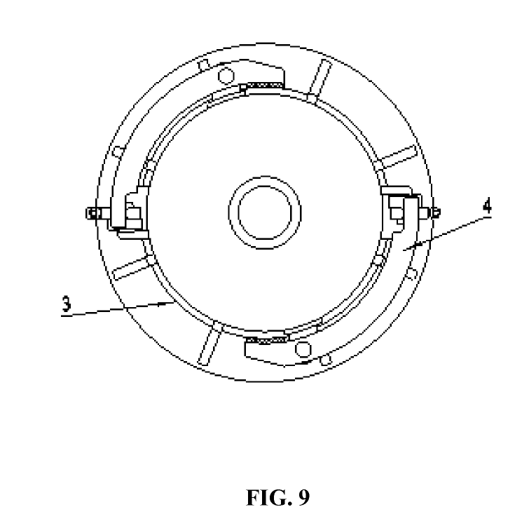

FIG. 8 and FIG. 9 are schematic diagrams of the structure of the inner-rotor inner-drum brake. The brake shoes are located on both sides of the generator 1, and the brake drum is located on top of the generator 1. Such structure is able to increase braking arm of force substantially without increasing the size of the brake system.

### EXAMPLE 8

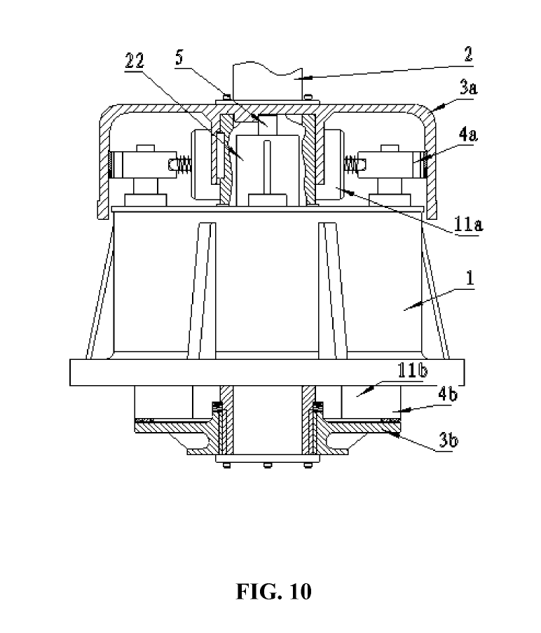

FIG. 10 is a schematic diagram of the structure of the hybrid brake, which is a combination of above-generator-brake and under-generator-brake, i.e. a combination of the drum brake in FIG. 1 and the underlying disc brake in FIG. 5, and both brakes constitute the brake system. Such structure is able to increase the braking force without increasing braking arm of force, thus better braking performance.

### EXAMPLE 9

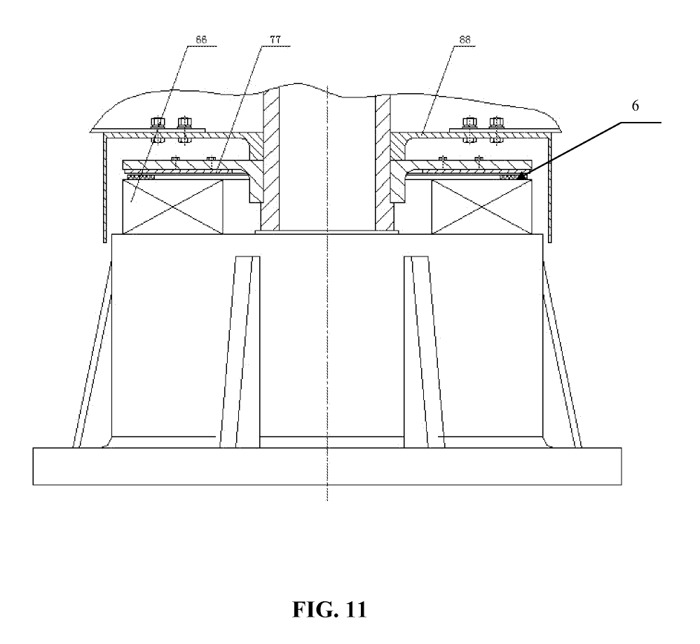

FIG. 11 is a schematic diagram of the structure of the disc brake without the safety pin. The braking disc is able to move upwards and downwards. Such brake system is simple in structure. A fixed part 66 is situated on top of the generator, and a disc 77 is connected with the lower flange 88. The brake is achieved by the disc 77 drawn by the electromagnetic actuator to the fixed part 66.

The brake system is able to reduce the vibration of the wind turbine in strong wind conditions effectively without the needs of reinforcing the wind turbine's ability to withstand strong winds, thus increase the safety and reliability of the vertical axis wind turbine.

### EXAMPLE 10

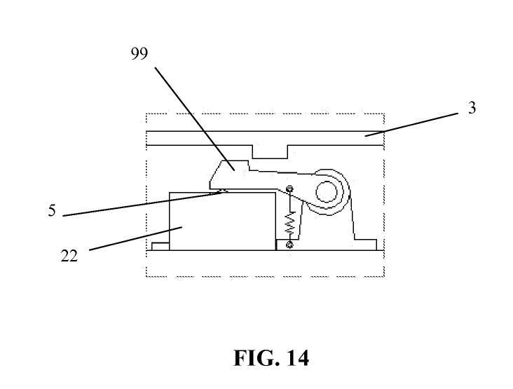

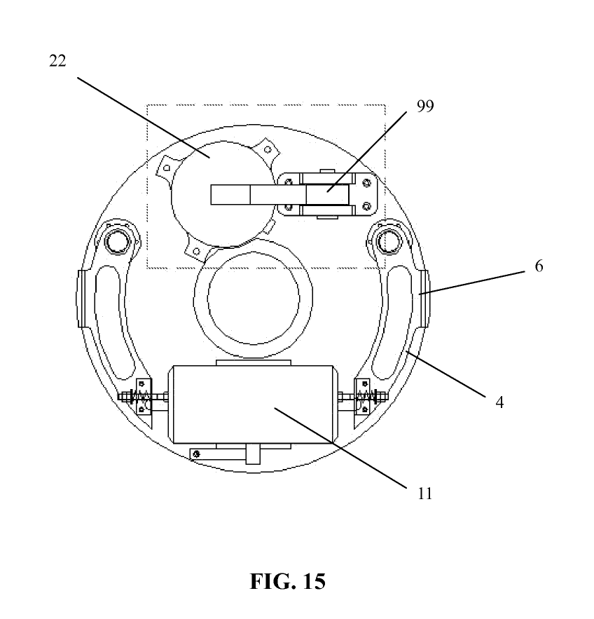

FIG. 14 and FIG. 15 are schematic diagrams of the structure of another type of drum brake. FIG. 15 is a top view of the drum brake, and FIG. 14 is the enlarged front view of the dash lined section in FIG. 15. The structure is similar to the drum brakes shown in FIG. 1 and FIG. 2, except that a safety locking device 99 is installed over the safety pin 5. The safety locking device 99 is a cantilever, with one end pivotally fixed and the other end features a prominence. One side of the prominence works with the ribs in the brake drum to brake the brake drum. The cantilever is equipped with a spring. When brake is not applied, the safety locking device 99 keeps untouched with the brake drum, and the wind turbine can rotate freely, while in braking period, the safety pin 5 goes up and pushes the safety locking device 99 to locking the brake drum.

When receiving braking signal, the safety pin electromagnetic actuator 22 is activated, and the safety pin 5 goes up and pushes the safety locking device 99 to lock the brake drum 3, effectively increasing the life of the safety pin 5 and cuts downtime. While on discharging the brake, the safety pin electromagnetic actuator 22 is deactivated and returns to its original position, making the safety pin 5 goes down and the safety locking device 99 returns to its original position, freeing the wind turbine.

While particular embodiments of the invention have been shown and described, it will be obvious to those skilled in the art that changes and modifications may be made without departing from the invention in its broader aspects, and therefore, the aim in the appended claims is to cover all such changes and modifications that fall within the true spirit and scope of the invention.

The invention claimed is:

1. A brake system for a vertical axis wind turbine, comprising:
a generator (1);
a brake device (3);
a vertical shaft (2);
brake shoes or brake calipers (4);
an electromagnetic actuator (11);
a friction lining (6);
a safety pin (5); and
a safety pin electromagnetic actuator (22);
wherein
said brake device (3) is connected with said vertical shaft (2);
said brake shoes or brake calipers (4) are controlled by said electromagnetic actuator (11);
said safety pin electromagnetic actuator (22) controls said salty pin (5); and
said brake device (3) is a brake drum or a brake disc.

2. The brake system of claim 1, wherein the axis of said brake device (3) is perpendicular to the ground.

3. The brake system of claim 1, wherein said safety pin (5) is perpendicular to the ground.

4. The brake system of claim 1, wherein said brake shoes or brake calipers (4) are symmetrically arranged to the rotor axis.

5. A method for braking the vertical axis wind turbine of claim 1, comprising:
when the wind speed exceeds the cut-out wind speed and long period braking is necessary, or maintenance services are needed, said electromagnetic actuator (11) is activated, and said electromagnetic actuator (11) controls said brake shoes or brake calipers (4), and through said friction lining (6) stops said brake device (3); said safety pin electromagnetic actuator (22) is then activated, making said safety pin (5) insert into the corresponding cut; and said electromagnetic actuator (11) is deactivated and said brake shoes or said brake calipers (4) return to the original positions.

6. The method of claim 5, wherein when the wind speed falls below the cut-out wind speed and long time braking is not necessary, said safety pin electromagnetic actuator (22) is deactivated, makes said safety pin (5) withdraw from the corresponding cut and return to its original position.

7. The method of claim 5, wherein the braking force from said electromagnetic actuator (11) increases from 0 to maximum within 2 minutes, and retains for 4 minutes, with the whole process taking 6 minutes; 5 minutes after the activation of said electromagnetic actuator (11), said safety pin electromagnetic actuator (22) is activated, making said safety pin (5) insert into the corresponding cut, then said electromagnetic actuator (11) is deactivated and makes said brake shoes or brake calipers (4) return to the original position.
